(19) United States
(12) Patent Application Publication
(10) Pub. No.: US 2015/0176316 A1
(43) Pub. Date: Jun. 25, 2015

(54) Device for Pivoting a Cover at a Sales Counter

(71) Applicant: Vieler International GmbH + Co. KG, Iserlohn (DE)

(72) Inventor: Martin Tschap, Iserlohn (DE)

(21) Appl. No.: 14/576,716

(22) Filed: Dec. 19, 2014

(30) Foreign Application Priority Data
Dec. 20, 2013 (DE) 10 2013 114 632.5

(51) Int. Cl. E05D 3/12; E05D 11/06

(52) U.S. Cl. CPC E05D 3/12; E05D 11/06; E05Y 2900/204

(57) ABSTRACT

The invention is a device for pivoting a cover, particularly a glass cover, at a sales counter about a horizontally arranged pivoting axis. One or several profiles are provided on which the cover is supported in such a manner that it moves in a pivoting manner indirectly or directly by at least one articulation. At least one gas pressure spring is provided that comprises two ends articulated to the profile, the cover, the articulation, or to another structural component. The gas pressure spring supports at least the first part of the pivoting movement of the cover up to the dead point. At the dead point the center of gravity of the cover stands vertically above its pivoting axis. Both ends of the gas pressure spring are movably supported and during the further pivoting of the cover beyond the dead point, the force-supporting action of the gas pressure spring is off.

### CROSS REFERENCE APPLICATIONS

This application claims the benefit of German Application No. 10 2013 114 632.5 filed Dec. 20, 2013, which is incorporated herein by reference for all purposes.

### BACKGROUND

The disclosure relates to a device for pivoting a cover, in particular a glass cover, at a sales counter that moves around a horizontally arranged pivot axis with one or several profiles on which the cover is supported in such a manner that it can move in a pivoting manner indirectly or directly by at least one articulation, with at least one gas pressure spring having two ends articulated to the profile, the cover, the articulation or to another structural component, wherein the gas pressure spring supports at least the first part of the pivoting movement of the cover up to the dead point, wherein at the dead point the center of gravity of the cover stands vertically above its pivoting axis. The concept cover denotes here every type of cover, therefore a cover that is arranged vertically in normal operation but also horizontally or obliquely arranged covers, bent or straight covers or also covers joined at angles. Even individual so-called toothed plates can function as covers in the sense of the disclosure.

It is always desirable in the case of sales counters, if the cover that is usually arranged between the customer and the goods in normal operation can be pivoted in order, for example, to resupply the sales counter but also in order to clean the sales counter or the cover, even from the inside. It can also be desirable to pivot the cover in order to make a self-service counter out of a service counter.

The pivoting motion of the cover is usually supported by a gas pressure spring in order to shape the pivot motion more simply and more ergonomically for the operator. An articulation is usually provided here that also comprises a glass holder for the cover and which can pivot the cover. If the cover is to be pivoted about a horizontal pivot axis, this is possible with traditional devices until the dead point has been reached at which the center of gravity of the cover is arranged vertically above the pivot axis. However, if the cover is pivoted further, for example, in order to make the inside of the cover better available for cleaning, it can happen that the cover experiences an additional impulse from gravity and also with the support of the gas pressure spring, which can lead to accidents or damage to things in the vicinity of the cover, of the profiles or also of the articulation. It can also occur that the cover moves past its dead point as a result of its intrinsic dynamics, which would lead to the same results. In addition, an operator who wants to return the cover back into its original state would have to work against the force of the gas pressure spring in order to make this possible.

EP2471418A1 shows a refrigerated counter whose glass cover is arranged so that it can pivot about a horizontal axis in order to convert the refrigerated counter from a sales counter into a self-service counter. A gas pressure spring is not provided here, for which reason the operator must hold the pivotable cover by hand if it has exceeded its center of gravity. However, in particular in the case of large counters the cover is very heavy, which can rapidly result in accidents.

DE29914069U1 describes the sales counter with a cover pivotably supported about a horizontal axis. The pivoting motion of the cover is supported by a gas pressure spring. However, it is only possible here to bring the cover into a relatively vertical position. This is not practical for an operator if he wishes to clean the inside of the cover since it cannot be easily reached through the limited opening of the glass. Furthermore, the cover is problematic when it is pivoted upward if work such as cleaning, stocking, etc. are to be carried out.

DE 3235371A1 describes a counter attachment with lifting metallic fittings. A spring is also provided here for supporting the lifting motion but even here the cover cannot be pivoted past its center of gravity, which again entails the previously cited problems.

The foregoing example of the related art and limitations related therewith are intended to be illustrative and not exclusive. Other limitations of the related art will become apparent to those of skill in the art upon a reading of the specification and a study of the drawings.

### SUMMARY

On aspect of the present disclosures therefore has the problem of developing a device for pivoting a cover that avoids the previously cited disadvantages and makes possible a pivoting of the cover even beyond the dead point in a reliable manner

The disclosure relates to a device for pivoting a cover, in particular a glass cover, at a sales counter that moves around a horizontally arranged pivot axis with one or several profiles on which the cover is supported in such a manner that it can move in a pivoting manner indirectly or directly by at least one articulation, with at least one gas pressure spring having two ends articulated to the profile, the cover, the articulation or to another structural component, wherein the gas pressure spring supports at least the first part of the pivoting movement of the cover up to the dead point, wherein at the dead point the center of gravity of the cover stands vertically above its pivoting axis, Both ends of the gas pressure spring are movably supported in such a manner that during the further pivoting of the cover in particular also beyond the dead point, the action of the gas pressure spring supporting the force is cut off and it therefore remains quasi without effect. An operator can then reliably move the cover even past its dead point and therefore reduce the danger of an accident. Movable in the sense of this invention is to be understood as any movement in which the particular end of the gas pressure spring moves in space, for example, by a pivoting movement or a translatory movement. A purely rotary movement about a point or an axis in which the point or the axis and therefore also the end of the gas pressure spring do not move in space does not fall under the concept of “movable”.

In traditional devices for pivoting a cover an end of the gas pressure spring is fixed on the profile only so that it can move in a rotary manner about a point. This produces the known and already mentioned disadvantages from the prior art. The force-supporting action of the gas pressure spring can be turned off as needed by the movable support of both ends of the gas pressure spring so that no force support of the gas pressure spring takes place in an undesired direction.

It is especially advantageous if the movement of the cover is dampened, in particular past the dead point or also in another area, for example, a few degrees before the dead point. In this manner the accelerating action of gravity on the cover is also reduced and the cover can be pivoted further by an operator in a more ergonomic and safer manner.

It is furthermore advantageous if a buffer, in particular consisting of an elastic material, is provided on which the cover comes to rest in its open position. This buffer prevents damage from occurring to objects even if there is no dampened pivoting movement of the cover. In addition, noise produced by the stop is dampened.

In a first, exemplary embodiment the first end of the gas pressure spring is arranged on a sliding element that is supported in or on the profile in a sliding manner, wherein a damper is provided that dampens the sliding movement of the sliding element. The gas pressure spring functions here as a coupling rod with which no piston movement takes place. This directly dampens the movement of the articulation and with it of the cover. It is possible to provide the gas pressure spring with an additional device such as a casing that prevents traction forces from being transferred onto the gas pressure spring.

For example, a linear damper can be used here as damper. The movement of the cover then takes place, for example, up to the dead point, as in the prior art. However, the first end of the gas pressure spring then moves on the sliding element in the profile against the action of the damper, as a result of which no piston movement of the gas pressure spring takes place and therefore the pivoting movement of the cover is dampened. Therefore, in this depicted embodiment the first end of the gas pressure spring is movably supported on the sliding element whereas the second end of the gas pressure spring is supported on the articulation in such a manner that it can pivot with the articulation.

It is advantageous in the previously cited depicted embodiment if the movement of the sliding element is limited by one or two stops. When two stops are used, the sliding element and the damper are arranged between them. This results in an exact and precisely adjusted possibility of movement for the first end of the gas pressure spring. The stop facing away from the cover can also directly serve as an adjustment element for the cover in the non-pivoted state. This can then be appropriately adjusted according to the exact arrangement and alignment of this stop.

It is furthermore preferred in this exemplary embodiment that caps of elastic material are provided on the sliding element and/or on the stop or stops. These caps serve to dampen the stops and sounds so that during the movement of the sliding element to the stops no disturbing noises such as, e.g., a clapping can be produced.

The previously described exemplary embodiment can be realized in an especially simple manner if the sliding element is arranged in a recess of the profile wherein an oblong hole is provided in the profile at the level of the sliding element. The first end of the gas pressure spring can then be connected through this oblong hole to the sliding element. The longitudinal hole allows the movement of the sliding element in the profile even when the gas pressure spring is connected to the sliding element.

It is of course also possible, as in this exemplary embodiment, that two gas pressure springs, two sliding elements and two dampers are provided on two adjacent covers arranged on a common profile. The dampers are then located, for example, adjacent to one another or above one another. The sliding elements are preferably arranged in the same recess of the profile and can slide in this recess past one another freely and independently of one another.

A second preferred exemplary embodiment provides that a second gas pressure spring is provided in addition to the first gas pressure spring. The pivoting movement of the cover takes place in at least two sections, wherein the first section of the pivoting movement is supported by the first gas pressure spring whereas the second section of the pivoting movement is supported by the second gas pressure spring. There can also be sections of the pivoting movement that have a quasi mixed form in which the first as well as the second gas pressure spring support the pivoting movement. In this embodiment the cover can be pivoted about an even greater angle. The first gas pressure spring is preferably supported by its first end on the articulation and by its second end on a pivot component whereas the second gas pressure spring is arranged with its first end on a control arm and with its second end on the profile. Therefore, the first gas pressure spring is again movably supported by both its ends since the pivot component as well as the articulation can be moved and the corresponding ends of the gas pressure spring move with them. The second gas pressure spring is movably supported only on its first end, with which it is arranged on the control arm. The second end of the second gas pressure spring is immobile but is rotatably arranged about a point on the profile.

In the last-described embodiment the pivot component is preferably designed as a deflection lever that is arranged in the state of rest of the cover in a recess in the profile.

Furthermore, a path limiter is advantageously provided on the control arm that limits the first section of the pivoting movement and with it the piston movement of the first gas pressure spring and brings up the second section of the pivoting movement. After the conclusion of the first section of the pivoting movement no more piston movement takes place then in the first gas pressure spring. Since the gas pressure spring is preferably not completely extended, the gas pressure spring does not receive any tractive forces, which is advantageous and extends the service life of the gas pressure spring.

Furthermore, it is advantageous in this embodiment if the control arm or the path limiter serves as cam for the second gas pressure spring and in the second section of the pivoting movement the cover is moved by the latter or by the articulation. As a result, the first end of the second gas pressure spring is also automatically moved and the second gas pressure spring is pivoted in this manner. It is also possible to construct the control arm in the pivot component in one piece.

Finally, a catch can be provided between the two sections of the pivoting movement that prevents the second section of the pivoting movement from taking place when the catch is not moved into an unlocking position.

In another preferred exemplary embodiment the first end of the gas pressure spring is fastened to a lever supported in a pivotably movable manner. The second end of the gas pressure spring is supported on the articulation. Both ends of the gas pressure spring are also supported in such a manner that they can rotate about an axis. During the pivoting movement of the cover, at first only the gas pressure spring becomes longer while the lever remains in its original position. Therefore, the gas pressure spring supports the pivoting of the cover. After the cover has reached the approximate area of its dead point the length of the gas pressure spring no longer changes. If the cover is not pivoted further, the lever now also pivots with it, wherein the first end of the gas pressure spring rotates only around the rotation point on the lever and therefore the gas pressure spring no longer affects the pivoting process of the cover. From the time at which the cover is still in its non-pivoted initial position until the time at which the gas pressure spring has reached its maximum length the first end of the gas pressure spring and the lever can rest on a contact area in order to save space and to bring about a more attractive total optical image of the closed cover on the sales counter. Here, the first end of the gas pressure spring can rest indirectly—for example with interpositioning of a part of the lever—or directly on the contact area.

The following embodiments and aspects thereof are described and illustrated in conjunction with systems, tool and methods which are meant to be exemplary and illustrative, not limiting in scope. In various embodiments, one or more of the above described problems have been reduced or eliminated, while other embodiments are directed to other improvements.

In addition to the exemplary aspects and embodiments described above, further aspects and embodiments will become apparent by reference to the accompanying drawings forming a part of this specification wherein like reference characters designate corresponding parts in the several views.

### BRIEF DESCRIPTION OF THE DRAWINGS

FIG. 1 is a first embodiment of the device in accordance with the invention in a perspective view with a non-pivoted cover.

FIG. 2 is a first sales counter in accordance with the invention with pivoted cover and the device in accordance with the invention according to FIG. 1.

FIG. 3 is a view according to FIG. 2 but with the cover pivoted further.

FIG. 4 is a view according to FIG. 1 with the cover pivoted according to FIG. 2.

FIG. 5 is a view according to FIG. 4 but with partially broken profile.

FIG. 6 is a view according to FIG. 5 but in a partially exploded view.

FIG. 7 is a sales counter with non-pivoted cover and a second exemplary embodiment of the device according to the invention.

FIG. 8 is a detailed view of the device from FIG. 7 with a partially pivoted cover.

FIG. 9 is the beginning of the pivoting movement of the cover in a device according to FIG. 7.

FIG. 10 is a pivoted cover according to FIG. 9 on the end of the first section of the pivoting movement.

FIG. 11 is the cover pivoted still further from FIG. 10.

FIG. 12 is the end position of the cover according to FIG. 11 after the conclusion of the second section of the pivoting movement.

FIG. 13 is a third embodiment of the device according to the invention in a perspective view.

FIG. 14 is a sales counter according to the invention with pivoted cover and a device according to the invention according to FIG. 13.

FIG. 15 is a view according to FIG. 14 but with the cover pivoted further.

FIG. 16 is the position of the cover from FIG. 15 in a perspective view.

Before explaining the disclosed embodiment of the present invention in detail, it is to be understood that the invention is not limited in its application to the details of the particular arrangement shown, since the invention is capable of other embodiments. Exemplary embodiments are illustrated in referenced figures of the drawings. It is intended that the embodiments and figures disclosed herein are to be considered illustrative rather than limiting. Also, the terminology used herein is for the purpose of description and not of limitation.

### DETAILED DESCRIPTION OF THE DRAWINGS

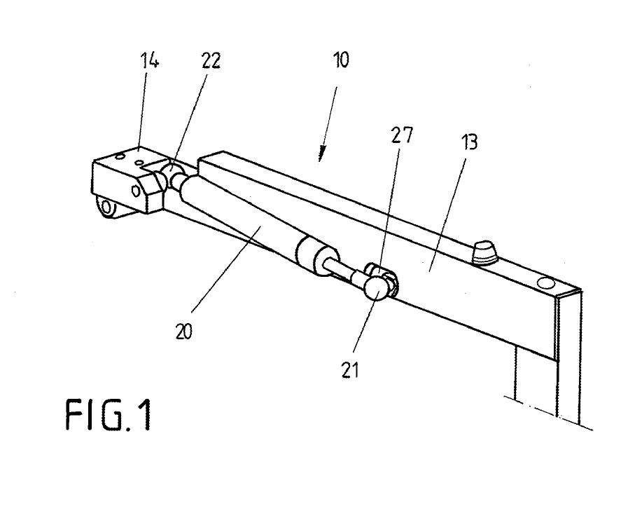

FIG. 1 shows a device 10 according to the invention with a gas pressure spring 20 arranged with its first 21 on an oblong hole 27 of the profile 13 and with its second end 22 on the articulation 14. The cover 12 is in FIG. 1 that is not shown here in detail in its initial state.

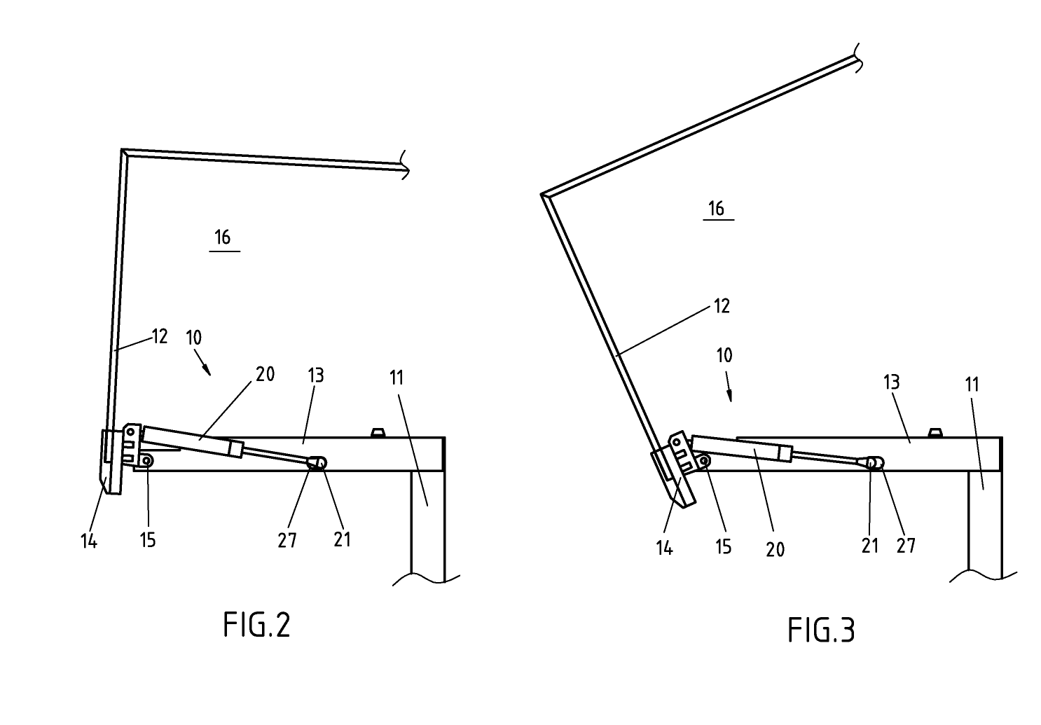

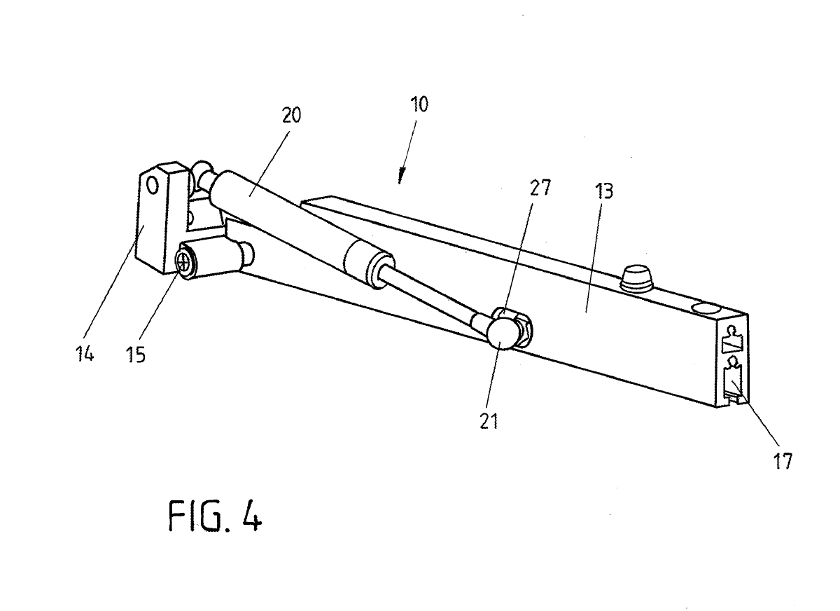

FIGS. 2 and 3 now show the course of the movement of cover 12 when executing its pivoting movement. In FIG. 2 the cover 12 has already been pivoted by ca. 90° about its point of rotation 15. However, the center of gravity 16 is still in front of the point of rotation 15 in FIG. 2, so that the pivoting movement of the cover 12 is supported in this area by the gas pressure spring 20. However, it is different during a continuation of the pivoting movement of the cover 12 up to the situation shown in FIG. 3. It can be recognized that now the center of gravity 16 is arranged behind the axis of rotation 15. In the area between the dead point and the situation shown in FIG. 3, in an arrangement according to the prior art in which the first end 21 of the gas pressure spring 20 is fixedly arranged on the profile 13, the cover 12 could fall to the rear in this last area of rotation due to its force of gravity, which can result in accidents and damage to goods. However, it is apparent from FIG. 3 that the first end 21 of the gas pressure spring 20 moved in the oblong hole 27 in comparison to the view in FIG. 2. As a result, the pivoting movement of the cover 12 is dampened even up to the position shown in FIG. 3. This results from the inner construction that is explained in detail in the FIGS. 4 to 6.

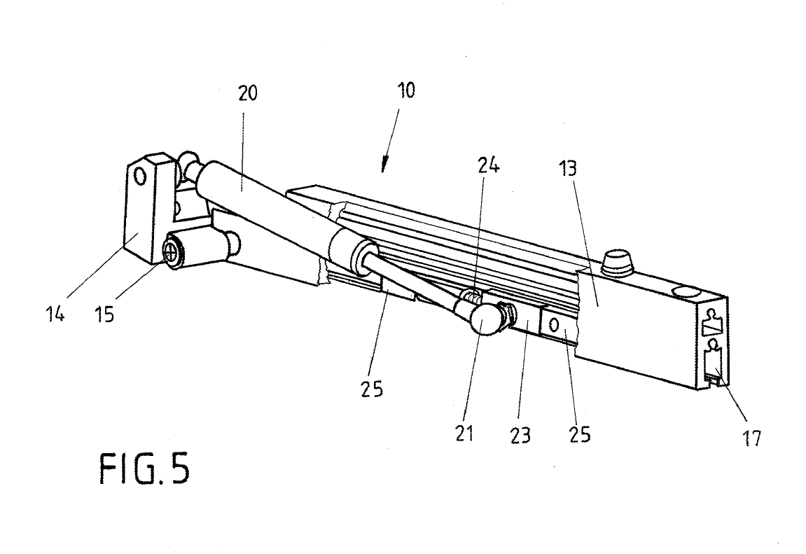

FIG. 4 shows a similar view here as in FIG. 1; however, here the cover 12 that was not shown is in the position shown in FIG. 2. The first end 21 of the gas pressure spring 20 is fastened on the sliding element 23 that is not shown here, inside the profile 13 and is arranged on the end of the oblong hole 27 on the right in the view. The sliding element 23 rests here on the stop 25, as FIG. 5 shows. A damper 24, here a linear damper, is arranged on the other side of the sliding element 23. If the cover is now brought from the position shown in FIG. 2 into the position shown in FIG. 3, the sliding element 23 moves in the recess 17 in the profile 13 in the FIGS. 4 and 5 to the left, so that the sliding element 23 cooperates with the damper 24. Here the first end 21 of the gas pressure spring 20 then also moves to the left until it comes to rest at the left end of the oblong hole 27, as is apparent from FIG. 3.

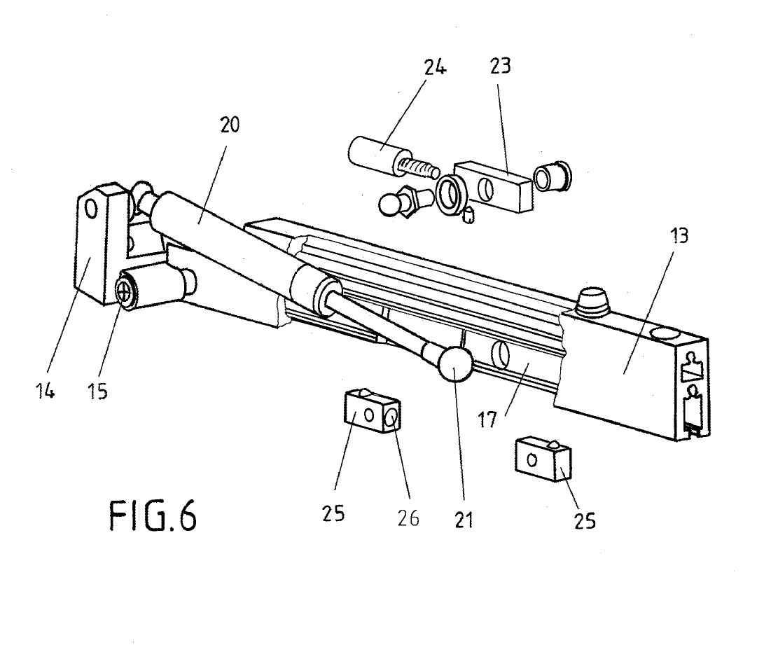

The exact components of this arrangement are also apparent in detail from FIG. 6 that shows a partially exploded view. It can be seen that two stops 25 are provided. These stops comprise caps 26 of elastic material on their end facing the damper 24 and the sliding element 23. These caps serve for sound damping when the sliding element 23 moves in the recess 17 in the profile 13. The sliding element 23 can preferably consist of a plastic here that is as abrasion-resistant and wear-resistant as possible but has a smooth surface.

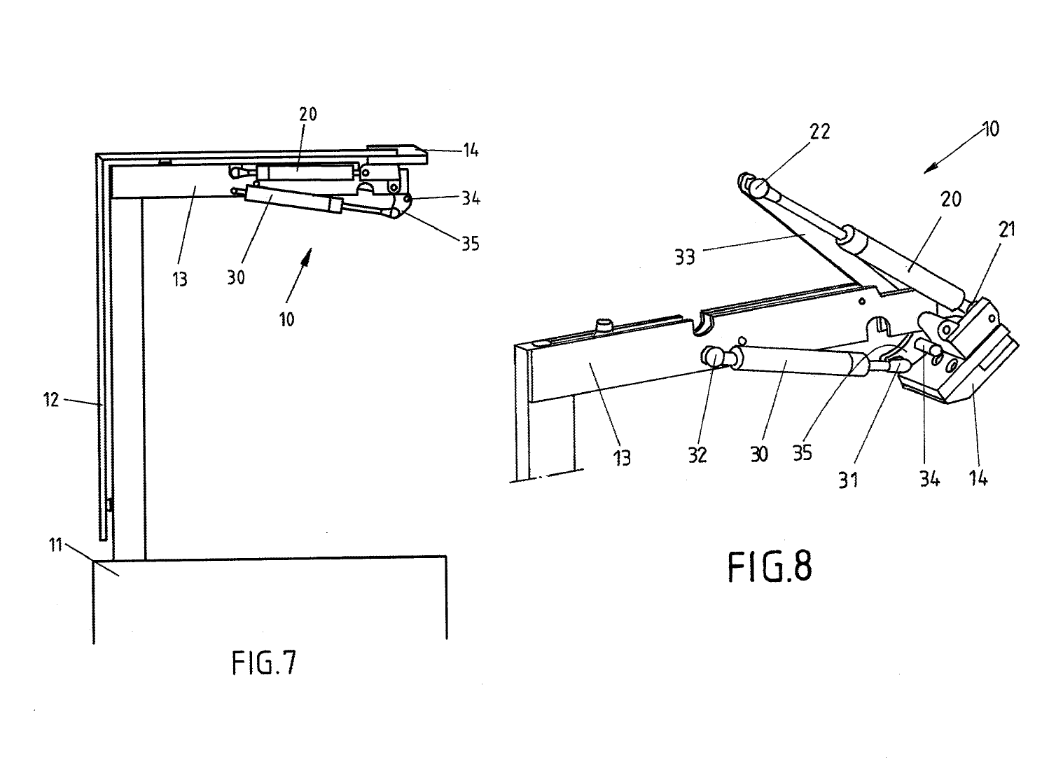

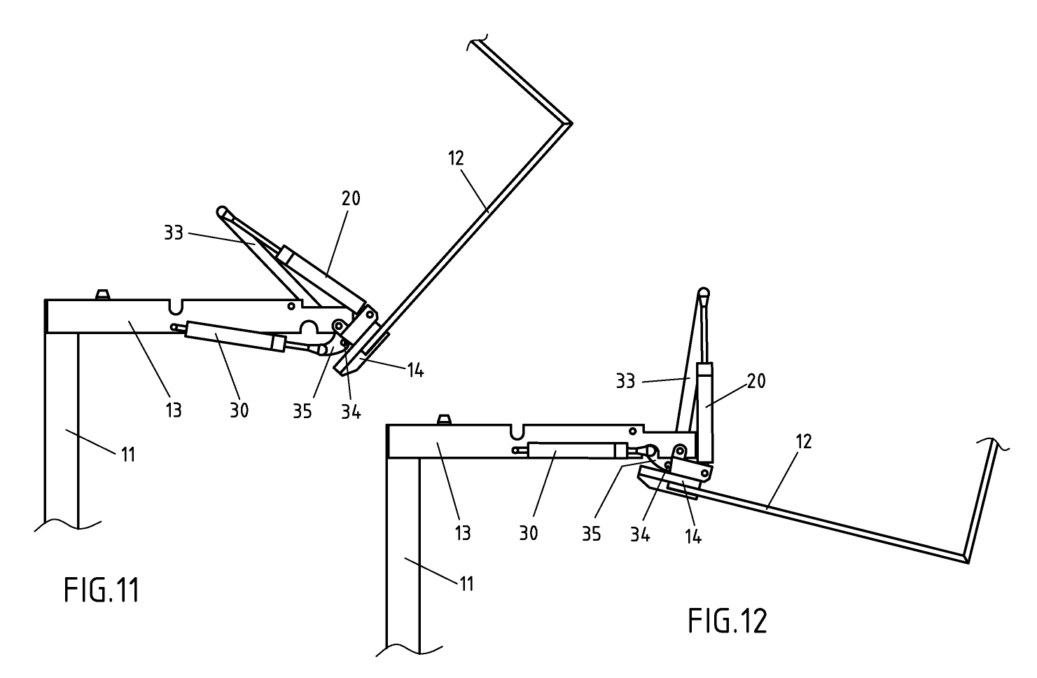

FIGS. 7 to 12 show another exemplary embodiment of the device 10 according to the invention. A second gas pressure spring 30 is also provided in addition to the first gas pressure spring 20, whose two ends 21, 22 are movably arranged. This gas pressure spring is also movably arranged with its first end 31, whereas the second end 32 is fixed on the profile 13 so that it can rotate about a point and therefore cannot move in space. FIG. 7 now shows the initial situation in which the cover 12 is arranged on the sales counter 11. Such arrangements are common in sales counters. The first gas pressure spring 20 is arranged with its first end 21 on the articulation 14, whereas the second end 22 is fixed to a pivoting component 33. A deflection lever is provided here as pivoting component 33. The second gas pressure spring 30 is fixed by its movable first end 31 on a control arm 35, whereas the second end 32 of the second gas pressure spring 30 is immovably but pivotably arranged on the profile.

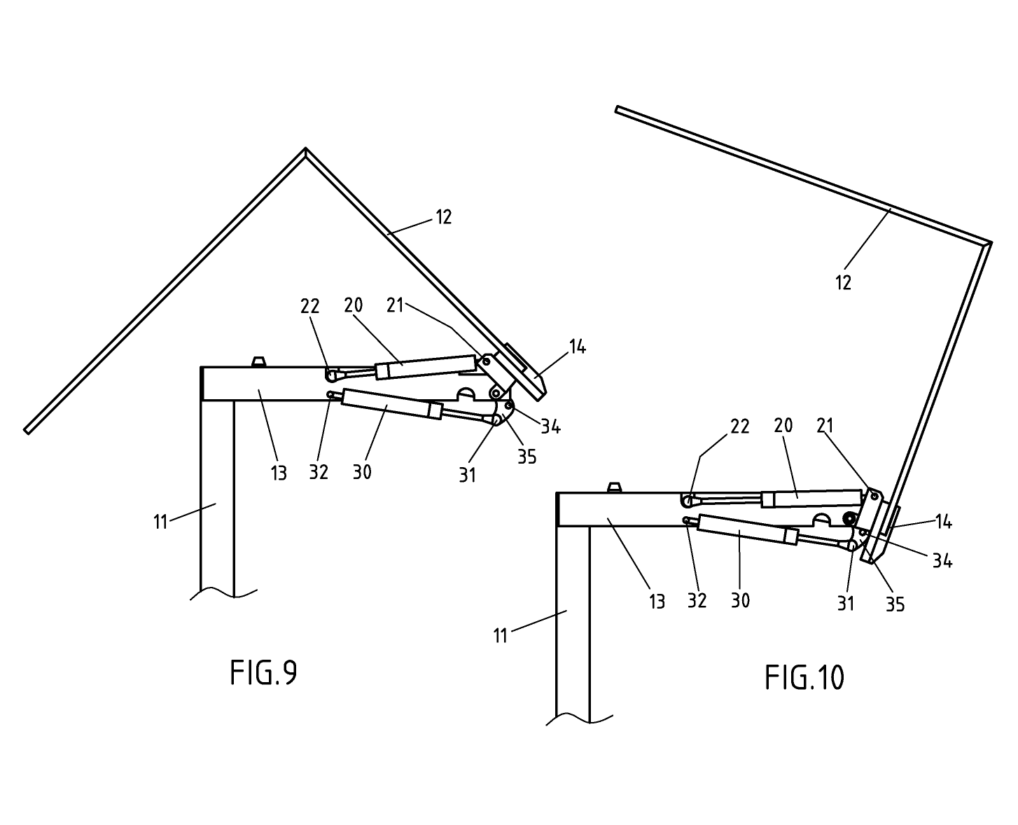

The movement course of the arrangement shown in FIG. 7 is shown in the FIGS. 9 to 12. The first gas pressure spring 20 operates, as is usual, in the FIGS. 9 and 10. This concerns the first section of the pivoting movement of the cover 12. The first gas pressure spring 20 becomes longer here but there is no piston movement in the first gas pressure spring 20 and the second gas pressure spring 30 does not participate in this movement course. In the position shown in FIG. 10 the articulation 14 then strikes against the path limiter 34. After this, no piston movement of the first gas pressure spring 20 takes place, that is, the first end 21 and the second end 22 of the first gas pressure spring 20 remain at the same distance from one another.

If the cover 12 is now pivoted further, the second section of the pivoting movement begins. During this pivoting movement of the cover 12 in the second section the articulation 14 and the path limiter 34 remain in contact. As a result, the control arm 35 is also moved and therefore also the first end 31 of the second gas pressure spring 30. FIG. 12 now shows the end of the second section of the pivoting movement of the cover 12.

Of course, it is also conceivable to provide another movement course in which at the end of the second section of the pivoting movement the cover 12 was pivoted even further from the sales counter 11. The situation shown in FIG. 12 has the advantage that during a cleaning of the inside of the cover 12 no cleaning fluid can run into the display surface of the counter and therefore, for example, contaminate goods on display there.

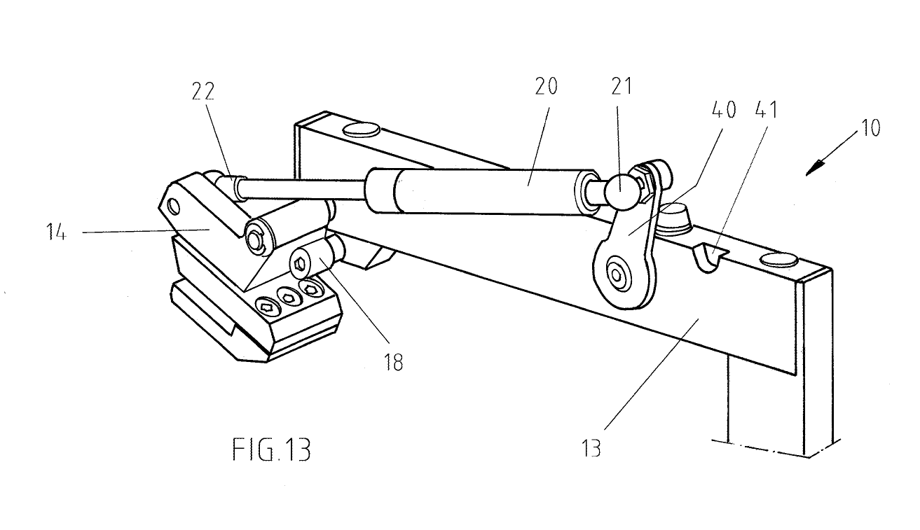

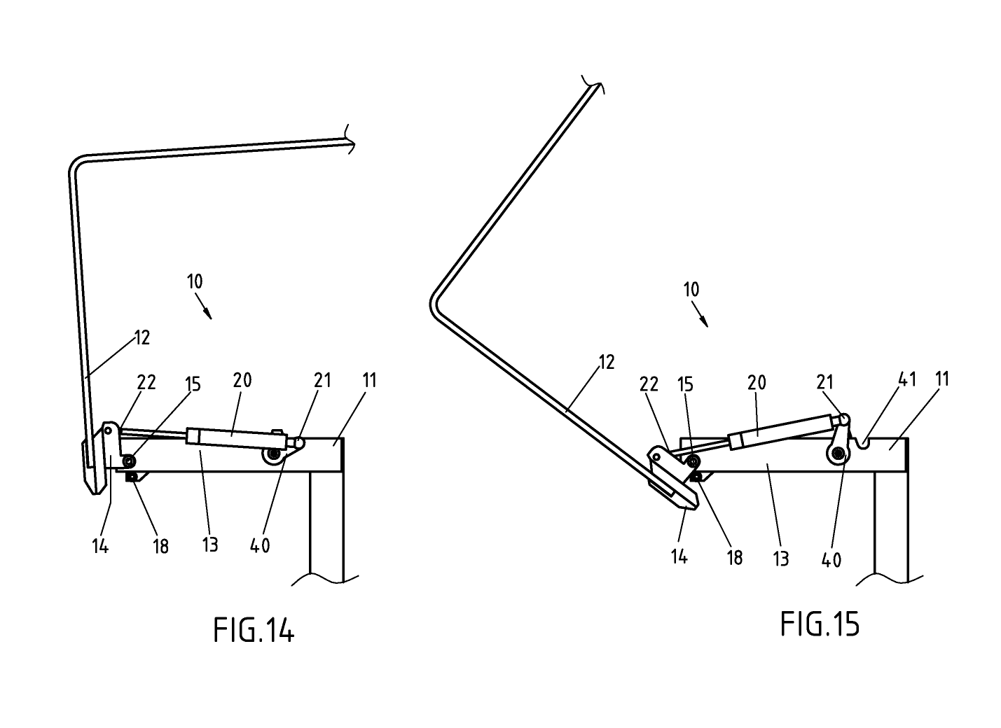

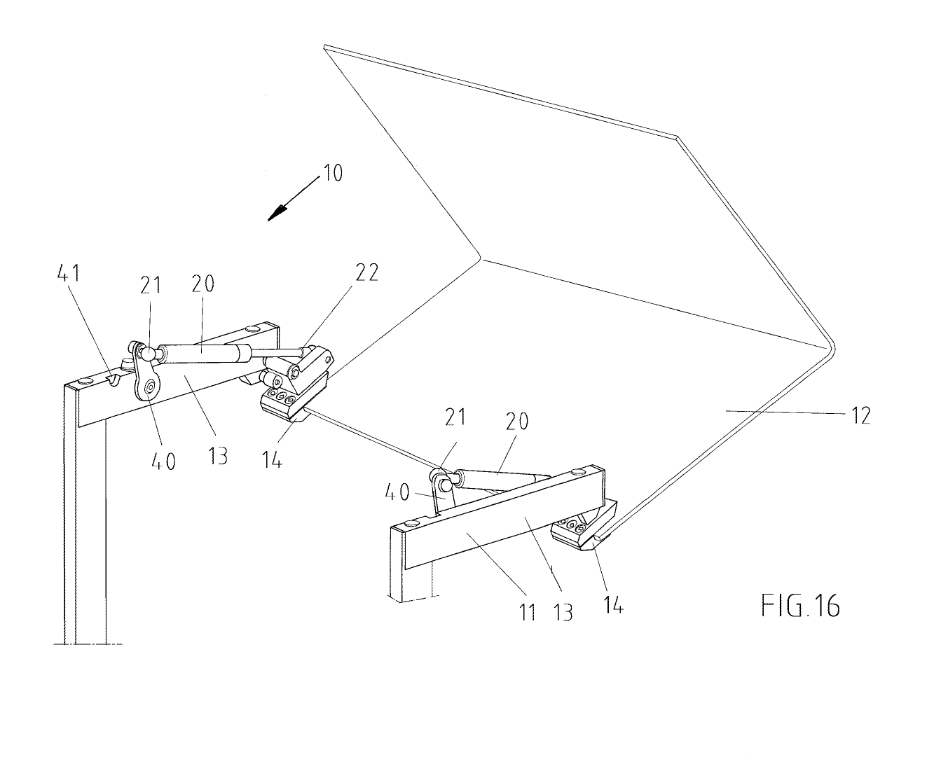

A third exemplary embodiment of the device 10 of the invention is shown in the FIGS. 13 to 16. The gas pressure spring 20 is articulated by its first end 21 to a lever 40. The gas pressure spring 20 is articulated by its second end 22 to the articulation 14. As is a particularly apparent from the FIGS. 14 and 15, at first the gas pressure spring 20 becomes longer upon a pivoting movement for opening the cover 12 in order to support this pivoting movement. However, as soon as the cover 12 has approximately reached its dead point, the length of the gas pressure spring no longer changes and the lever 40, to which the first end 21 of the gas pressure spring 20 is articulated, begins to pivot. This pivoting movement of the cover 12 can then be carried out further until the maximum opening of the cover 12 has been achieved, as shown in the FIGS. 15 and 16. The articulation 14 now rests on the buffer 18 so that no hard jolt occurs at the end of the movement of the cover 12. Such a buffer 18 could also be designed in another way and, for example, directly cooperate with the cover 12.

In conclusion the embodiments presented here are only exemplary realizations of the invention. The invention is not limited to them but rather amendments and modifications are possible. It can be recognized that in all embodiments both ends of the gas pressure spring move in space, frequently also by movements with a rotary and translatory component. Therefore, a pure rotary movement about an axis running through one end of the gas pressure spring is not meant. As a result of this movement of the gas pressure spring its effect can be quasi-eliminated in order to avoid the previously cited disadvantages. Therefore even other embodiments of the concept of the invention that precisely describe such movements of the gas pressure spring are expressly comprised by the invention. The concept “dead point” is also to be broadly construed in connection with this invention. This does not mean that the support of the gas pressure spring acts exactly until the achieving of the dead point and is directly turned off there. Rather, the supporting action of the gas pressure spring can also be turned off already somewhat before or a little after achieving the physical dead point. At which point this precisely occurs depends on the particular application.

While a number of exemplary aspects and embodiments have been discussed above, those of skill in the art will recognize certain modifications, permutations, additions and sub-combinations therefore. It is therefore intended that the following appended claims hereinafter introduced are interpreted to include all such modifications, permutations, additions and sub-combinations are within their true spirit and scope. Each apparatus embodiment described herein has numerous equivalents.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims. Whenever a range is given in the specification, all intermediate ranges and subranges, as well as all individual values included in the ranges given are intended to be included in the disclosure. When a Markush group or other grouping is used herein, all individual members of the group and all combinations and subcombinations possible of the group are intended to be individually included in the disclosure.

In general the terms and phrases used herein have their art-recognized meaning, which can be found by reference to standard texts, journal references and contexts known to those skilled in the art. The above definitions are provided to clarify their specific use in the context of the invention.

### LIST OF REFERENCE NUMERALS

10 device

11 sales counter

12 cover

13 profile

14 articulation

15 pivot axis of 12

16 center of gravity of 12

17 recess in 13

18 buffer

20 first gas pressure spring

21 first end of 20

22 second end of 20

23 sliding element

24 damper

25 stop

26 cap

27 oblong hole

30 second gas pressure spring

31 first end of 30

32 second end of 30

33 pivoting component

34 path limiter

35 control arm

40 lever

41 contact area

I claim:

1. A device for pivoting a cover, in particular a glass cover, at a sales counter (11) about a horizontally arranged pivot axis comprising:
at least one profiles on which the cover is supported in such a manner that it can move in a pivoting manner indirectly or directly by at least one articulation;
with at least one gas pressure spring that comprises two ends articulated to the profile, the cover, the articulation or to another structural component;
wherein the gas pressure spring supports at least the first part of the pivoting movement of the cover up to a dead point, wherein at the dead point a center of gravity of the cover stands vertically above its pivoting axis;
both ends of the gas pressure spring are movably supported in such a manner that the gas pressure spring moves or pivots during the pivoting movement of the cover in space; and
during the further pivoting of the cover past its dead point, the force-supporting action of the gas pressure spring is turned off.

2. The device of claim 1, wherein the movement of the cover is dampened.

3. The device of claims 1, wherein a buffer is provided on which the cover comes to rest indirectly or directly in its open position.

4. The device of claim 1, wherein the first end of the gas pressure spring is arranged on a sliding element and the second end of the gas pressure spring is arranged on the articulation, that is supported in a sliding manner in or on the profile, wherein a damper such as a linear damper is provided that prevents a sliding movement of the sliding element and therefore prevents a piston movement of the gas pressure spring.

5. The device of claim 4, wherein the movement of the sliding element is limited by one or two stops (25).

6. The device of claim 5, characterized in that caps of elastic material for dampening stops and sound are provided on the sliding element and/or on the stop or stops.

7. The device of claim 4, wherein the sliding element is arranged in a recess of the profile and that an oblong hole is provided in the profile at the level of the sliding element through which the connection of the gas pressure spring to the sliding element takes place.

8. The device of claim 1, wherein a second gas pressure spring is provided additionally to the first gas pressure spring, wherein the pivoting movement of the cover takes place in at least two sections, wherein the first section of the pivoting movement is supported by the first gas pressure spring and the second section of the pivoting movement is supported by the second gas pressure spring.

9. The device of claim 8, wherein the first gas pressure spring is supported by its first end on the articulation and by its second end on a pivot component, whereas the second gas pressure spring is also arranged by its first end on a control arm and by its second end on the profile.

10. The device of claim 8, wherein the pivoting component is a deflection lever.

11. The device of claim 8, wherein a path limiter is provided on the control arm that limits the first section of the pivoting movement and with it the axial movement of the first gas pressure spring and brings about the second section of the pivoting movement.

12. The device of claim 8, wherein a the control arm and/or the path limiter serves as cam for the second gas pressure spring and in the second section of the pivoting movement the cover is moved by the latter or by the articulation.

13. The device of claim 1, wherein a catch is provided that prevents the second section of the pivoting movement if it is not brought into an unlocking position.

14. The device of claim 1, wherein the gas pressure spring is supported by its first end on a lever that can move in a pivoting manner and by its second end on the articulation, wherein both ends of the gas pressure spring are pivotably supported.

15. The device of claim 14, wherein a contact area is provided on which the lever and, indirectly or directly, also the first end of the gas pressure spring rest when the cover is in its closed position up to the point of the pivoting movement at which the gas pressure spring is maximally extended.
